(19) United States
(12) Patent Application Publication
(10) Pub. No.: US 2013/0049722 A1
(43) Pub. Date: Feb. 28, 2013

(54) Low-dropout linear voltage stabilizing circuit and system

(71) Applicant: Junwei Huang, Chengdu (CN)

(72) Inventor: Junwei Huang, Chengdu (CN)

(73) Assignee: IPGoal Microelectronics (SiChuan) Co., Ltd.

(21) Appl. No.: 13/473,719

(22) Filed: May 17, 2012

(30) Foreign Application Priority Data
Aug. 30, 2011 (CN) 201110252483.0

(51) Int. Cl. G05F 1/10

(52) U.S. Cl. 323/281

(57) ABSTRACT

A low-dropout linear voltage stabilizing circuit includes a power source terminal, a reference voltage terminal, an outputting terminal, a load and a grounding terminal, a fast channel circuit connected between the power source terminal and the load for adjusting voltage values outputted by the outputting terminal and a slow channel circuit connected between the power source terminal and the load for stabilizing the voltage values outputted by the outputting terminal The fast channel circuit and the slow channel circuit are connected to the outputting terminal The slow channel circuit is connected to the reference voltage terminal. The fast channel circuit comprises a first FET and a controlling subcircuit. The slow channel circuit comprises an operational amplifier connected to the reference voltage terminal, a first resistance, a second resistance connected to the first resistance and the first FET. A low-dropout linear voltage stabilizing system is further provided.

### BACKGROUND OF THE PRESENT INVENTION

1. Field of Invention

The present invention relates to a voltage stabilizing circuit and system, and more particularly to a low-dropout linear voltage stabilizing circuit able to leave out an external decoupling capacitor and a system thereof.

2. Description of Related Arts

LDO (low dropout regulator), as a low-dropout linear voltage regulator, has low noise and is fit for integrity and thus is widely applied in electronic systems.

Referring to FIG. 1, a structure of a conventional LDO circuit is showed, wherein opamp refers to a single-stage operational amplifier; MP refers to a field effect transistor (FET); a feedback circuit comprises a first resistance R11 and a second resistance R22. Because the conventional LDO structure has a relatively low bandwidth, when a power source voltage VDD′ or a load ILOAD is changing rapidly, an outputting terminal VOUT′ has a big overshoot or a big decrease and it takes a relatively long time for the outputting terminal VOUT′ to recover normal outputting values, which greatly degrades system performance and even leads to a function failure. In order to solve the above problem, a grounded decoupling capacitor CO having a capacitance value of several micro farads is usually connected to the outputting terminal VOUT′, so that the capacitor CO is able to store or supply electric charges when the power source voltage VDD′ or the load ILOAD is changing rapidly so as to keep values outputted by the outputting terminal VOUT′ in a correct range. In the conventional LDO structure, VOUT′=VREF′*(R11+R22)/R22, wherein VREF′ is a reference voltage.

However, in a conventional electronic system, in order to produce a compact circuit board and reduce cost, the external decoupling capacitor CO is desired to be left out, accordingly the LDO circuit is usually designed to have a very big loop bandwidth and a very low loop gain to improve speed of response. However two problems exist in this design. The big loop bandwidth results in big power consumption; the low loop gain reduces outputting precision.

### SUMMARY OF THE PRESENT INVENTION

Thus, it is necessary to provide a low-dropout linear voltage stabilizing circuit able to reduce power consumption, maintain outputting precision and leave out an external decoupling capacitor and a system thereof.

A low-dropout linear voltage stabilizing circuit comprises a power source terminal, a reference voltage terminal, an outputting terminal, a load and a grounding terminal connected to the load. The low-dropout linear voltage stabilizing circuit further comprises a fast channel circuit connected between the power source terminal and the load for adjusting voltage values outputted by the outputting terminal and a slow channel circuit connected between the power source terminal and the load for stabilizing the voltage values outputted by the outputting terminal. The fast channel circuit and the slow channel circuit are both connected to the outputting terminal. The slow channel circuit is connected to the reference voltage terminal The fast channel circuit comprises a first FET and a controlling subcircuit connected to the first FET. The slow channel circuit comprises an operational amplifier connected to the reference voltage terminal, a first resistance connected to the operational amplifier, a second resistance connected to the first resistance and the first FET. In other preferred embodiments of the low-dropout linear voltage stabilizing circuit of the present invention, the fast channel circuit can comprise other element or circuit for realizing a function of the fast channel circuit; the slow channel circuit can comprise other element or circuit for realizing a function of the slow channel circuit.

A low-dropout linear voltage stabilizing system comprises a power source terminal, a reference voltage terminal, an outputting terminal, a load and a grounding terminal connected to the load. The low-dropout linear voltage stabilizing system further comprises a fast channel circuit connected between the power source terminal and the load for adjusting voltage values outputted by the outputting terminal and a slow channel circuit connected between the power source terminal and the load for stabilizing the voltage values outputted by the outputting terminal. The fast channel circuit and the slow channel circuit are both connected to the outputting terminal. The slow channel circuit is connected to the reference voltage terminal.

Compared to conventional arts, the low-dropout linear voltage stabilizing circuit and its system of the present invention are able to quickly respond to the rapid changes of the power source terminal or the load through the fast channel circuit, so as to quickly turn a voltage value outputted by the outputting terminal back to normal. The low-dropout linear voltage stabilizing circuit and system of the present invention also have a simple structure, reduce the power consumption and maintain the outputting precision of the outputting terminal

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a conventional low-dropout linear voltage stabilizing circuit.

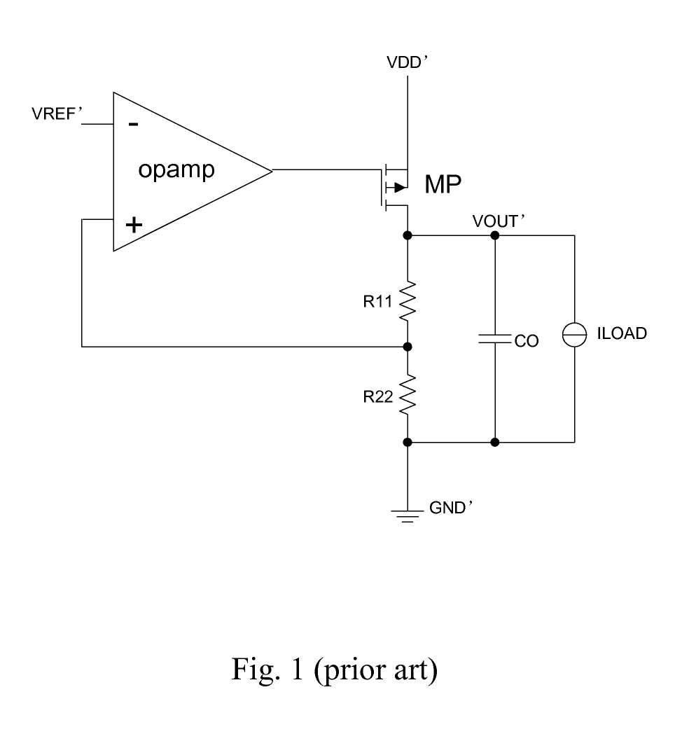

FIG. 2 is a sketch view of a low-dropout linear voltage stabilizing system according to a preferred embodiment of the present invention.

FIG. 3 is a sketch view of a low-dropout linear voltage stabilizing circuit according to the preferred embodiment of the present invention.

### DETAILED DESCRIPTION OF THE PREFERRED EMBODIMENT

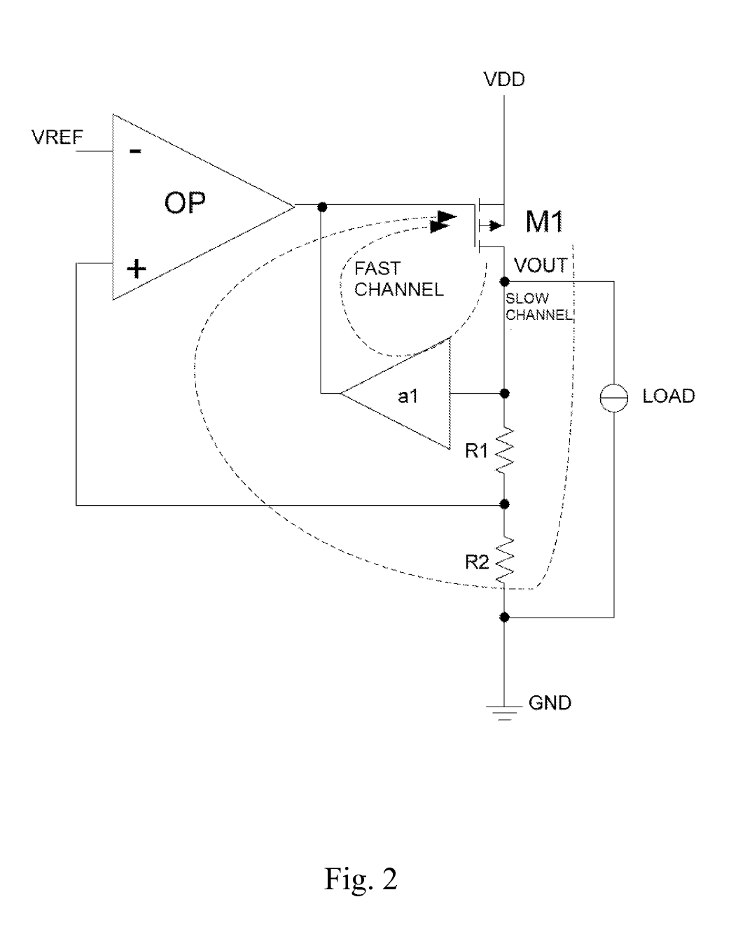

Referring to FIG. 2 of the drawings, according to a preferred embodiment of the present invention, a low-dropout linear voltage stabilizing system comprises a power source terminal VDD, a fast channel circuit connected to the power source terminal VDD, a slow channel circuit connected to the power source terminal VDD, a reference voltage terminal VREF connected to the slow channel circuit, an outputting terminal VOUT connected to the fast channel circuit and the slow channel circuit, a load LOAD and a grounding terminal GND. The fast channel circuit comprises a first FET M1 and a controlling subcircuit a1. The slow channel circuit comprises an operational amplifier OP, a first resistance R1, a second resistance R2 and the first FET M1. The fast channel circuit is for quickly responding to rapid changes of the power source terminal VDD or the load LOAD so as to turn voltage values outputted by the outputting terminal VOUT back to normal; the slow channel circuit is for stabilizing the voltage values outputted by the outputting terminal VOUT when the power source terminal VDD or the load LOAD has no change. In other preferred embodiments of the low-dropout linear voltage stabilizing system of the present invention, the fast channel circuit can comprise other element or circuit for realizing a function of the fast channel circuit; the slow channel circuit can comprise other element or circuit for realizing a function of the slow channel circuit

According to the preferred embodiment of the present invention, the low-dropout linear voltage stabilizing system has following connections. The power source terminal VDD and a source electrode of the first FET M1 are connected. A gate electrode of the first FET M1 is connected to an outputting terminal of the operational amplifier OP and a first end of the controlling subcircuit a1. A drain electrode of the first FET M1 is connected to a second terminal of the controlling subcircuit a1, a first terminal of the first resistance R1, a first terminal of the load LOAD and the outputting terminal VOUT. A non-inverting inputting terminal of the operational amplifier OP is connected to a second terminal of the first resistance R1 and a first terminal of the second resistance R2. An inverting inputting terminal of the operational amplifier OP is connected to the reference voltage terminal VREF. A second terminal of the second resistance R2 and a second terminal of the load LOAD are both connected to the grounding terminal GND.

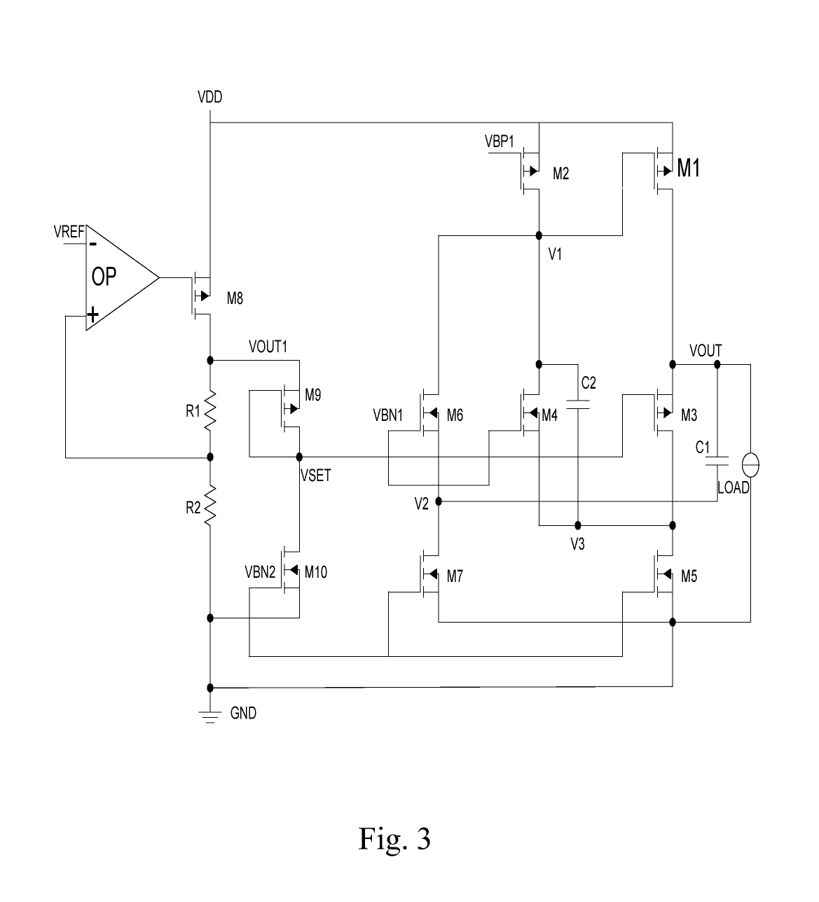

Referring to FIG. 3, a low-dropout linear voltage stabilizing circuit is specifically shown. A slow channel circuit further comprises a second FET M2, a third FET M3, a fourth FET M4, a fifth FET M5, a sixth FET M6, a seventh FET M7, an eighth FET M8, a ninth FET M9 and a tenth FET M10, besides the first FET M1, the operational amplifier OP, the first resistance R1 and the second resistance R2. A fast channel circuit comprises a first channel and a second channel, wherein the first channel comprises a first capacitor C1, the first FET M1, the second FET M2, the sixth FET M6 and the seventh FET M7; the second channel comprises a second capacitor C2, the third FET M3, the second FET M2 and the first FET M1. In FIG. 3, a controlling subcircuit al comprises the first capacitor C1, the second capacitor C2, the second FET M2, the third FET M3, the sixth FET M6 and the seventh FET M7, wherein the first capacitor C1, the first FET M1, the second FET M2, the sixth FET M6 and the seventh FET M7 form the first channel; the second capacitor C2, the third FET M3, the second FET M2 and the first FET M1 form the second channel.

According to the preferred embodiment of the present invention, the low-dropout linear voltage stabilizing circuit has following connections. A gate electrode of the first FET M1 is connected to a drain electrode of the second FET M2, a drain electrode of the sixth FET M6, a drain electrode of the fourth FET M4 and a first terminal of the second capacitor C2. A drain electrode of the first FET M1 is connected to a source electrode of the third FET M3, a first terminal of the first capacitor C1 and a first terminal of the load LOAD. A gate electrode of the second FET M2 is connected to a first voltage terminal VBP1. A gate electrode of the third FET M3 is connected to a gate electrode and a drain electrode of the ninth FET M9, a drain electrode of the tenth FET M10 and a voltage controlling terminal VSET. A drain electrode of the third FET M3 is connected to a source electrode of the fourth FET M4, a second terminal of the second capacitor C2 and a drain electrode of the fifth FET M5. A gate electrode of the fourth FET M4 and a gate electrode of the sixth FET M6 are both connected to a second voltage terminal VBN1. A gate electrode of the fifth FET M5, a gate electrode of the seventh FET M7 and a gate electrode of the tenth FET M10 are all connected to a third voltage terminal VBN2. A source electrode of the sixth FET M6 is connected to a drain electrode of the seventh FET M7 and a second terminal of the first capacitor C1. A gate electrode of the eighth FET M8 is connected to an outputting terminal of the operational amplifier OP. A drain electrode of the eighth FET M8 is connected to a first terminal of the first resistance R1, a source electrode of the ninth FET M9 and an outputting controlling terminal VOUT1. A non-inverting inputting terminal of the operational amplifier OP is connected to a second terminal of the first resistance R1 and a first terminal of the second resistance R2. An inverting inputting terminal of the operational amplifier OP is connected to the reference voltage terminal VREF. A source electrode of the first FET M1, a source electrode of the second FET M2 and a source electrode of the eighth FET M8 are all connected to the power source terminal VDD. A second terminal of the second resistance R2, a source electrode of the tenth FET M10, a source electrode of the seventh FET M7, a source electrode of the fifth FET M5 and a second terminal of the load LOAD are all connected to a grounding terminal GND.

The low-dropout linear voltage stabilizing circuit and its system of the present invention have following working principles.

When the power source terminal VDD and the load LOAD are both relatively stable, the slow channel circuit determines a voltage value outputted by the outputting terminal VOUT. According to FIG. 3, the outputting terminal VOUT1 outputs a voltage value VOUT1=VREF*(R1+R2)/R2; the voltage controlling terminal VSET outputs a voltage value VSET=VOUT1−VGS(M9). According to the calculated voltage value VSET and through a loop comprising the second FET M2, the third FET M3, the fourth FET M4, the fifth FET M5 and the first FET M1, a voltage value outputted by the outputting value VOUT is determined; the outputting terminal VOUT outputs the voltage value VOUT=VSET+VGS(M3). In order to realize VOUT=VOUT1, it is required that VGS(M3)=VGS(M9). And thus the voltage value outputted by the outputting terminal VOUT is determined by adjusting currents running through the third FET M3 and the ninth FET M9 and adjusting sizes of the third FET M3 and the ninth FET M9, wherein VGS(M9) stands for a gate-source voltage of the ninth FET M9; VGS(M3) stands for a gate-source voltage of the third FET M3.

When the power source terminal VDD and the load LOAD are changing rapidly, a current of the outputting terminal VOUT suddenly increases or decreases. An example of the rapidly changing load LOAD is following.

When the load LOAD is changing rapidly and the current of the outputting terminal VOUT suddenly increases, the voltage of the outputting terminal VOUT tends to decrease and then the third FET M3 and the first capacitor C1 are able to simultaneously detect changes of the outputting terminal VOUT. The third FET M3 is formed in a common gate structure and thus has a relatively quick speed of response, so the third FET M3 sends information of the decreasing voltage of the outputting terminal VOUT into the second capacitor C2 in a very short time. A capacitor has a feature that a voltage of a second terminal increases or decreases identically to a voltage of a first terminal. The first terminal of the second capacitor C2 is connected to the gate electrode of the first FET M1, so a voltage of the gate electrode of the first FET M1 decreases, i.e., a gate-source voltage of the first FET M1 VGS (M1) rapidly increases, and a current running through the first FET M1 also rapidly increases, so as to rapidly catch up with the changes of the load LOAD. Similarly, the first capacitor C1 rapidly leads to a decreasing voltage of the source electrode of the sixth FET M6 and further an increasing gate-source voltage of the sixth FET M6 VGS(M6) so as to increase a current running therethrough, in such a manner that the gate-source voltage of the first FET M1 is rapidly dragged down by a current running through the sixth FET M6 and the current running through the first FET M1 increases, so as to rapidly catch up with the changes of the load LOAD.

When a current of the outputting terminal VOUT suddenly decreases, a voltage of the outputting terminal VOUT tends to increase and then the third FET M3 and the first capacitor C1 are able to simultaneously detect changes of the outputting terminal VOUT. The third FET M3 is made in a common gate structure and thus has a relatively quick speed of response, so the third FET M3 sends information of the increasing voltage of the outputting terminal VOUT into the second capacitor C2 in a very short time. A capacitor has a feature that a voltage of a second terminal increases or decreases identically to a voltage of a first terminal The first terminal of the capacitor C2 is connected to the gate electrode of the first FET M1, so a voltage of the gate electrode of the first FET M1 increase, i.e., a gate-source voltage of the first FET M1 VGS(M1) rapidly decreases, and a current running through the first FET M1 also rapidly decreases, so as to rapidly catch up with the changes of the load LOAD. Similarly, the first capacitor C1 is able to rapidly leads to an increasing voltage of the source electrode of the sixth FET M6 and further a decreasing gate-source voltage of the sixth FET M6 VGS(M6) so as to decrease a current running therethrough, in such a manner that a voltage of the gate electrode of the first FET M1 is rapidly dragged up by a current running through the sixth FET M6 and a current running through the first FET M1 decreases, so as to catch up with the changes of the load LOAD.

According to the preferred embodiment of the present invention, the first capacitor C1 is connected between the outputting terminal VOUT and a second connecting terminal V2; the second capacitor C2 is connected between a first connecting terminal V1 and a third connecting terminal V3. When the power source terminal VDD and the load LOAD are relatively stable, the first capacitor C1 and the second capacitor C2 consume no power; when the power source terminal VDD and the load LOAD are changing rapidly, the first capacitor C1 and the second capacitor C2 are able to respond quickly and save power consumption.

In other preferred embodiments, capacitors are optionally connected between the first connecting terminal V1 and the second connecting terminal V2, between the first connecting terminal V1 and the outputting terminal VOUT, between the first connecting terminal V1 and the third connecting terminal V3 and between the second connecting terminal V2 and the outputting terminal VOUT to form a fast channel.

Moreover, according to the preferred embodiment of the present invention, the fast channel circuit comprises the first channel and the second channel. In other preferred embodiments, the first channel can be omitted and only the second channel functions as a fast channel circuit.

The low-dropout linear voltage stabilizing circuit and its system of the present invention are able to quickly respond to the rapid changes of the power source terminal VDD or the load LOAD through the fast channel circuit to quickly turn the voltage outputted by the outputting terminal VOUT back to normal, and stabilize the voltage outputted by the outputting terminal VOUT through the slow channel circuit when the power source terminal VDD or the load LOAD are stable. The low-dropout linear voltage stabilizing circuit and its system of the present invention also have a simple structure, reduce the power consumption and maintain the outputting precision of the outputting terminal.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A low-dropout linear voltage stabilizing circuit comprising a power source terminal, a reference voltage terminal, an outputting terminal, a load and a grounding terminal connected to said load, and further comprising a fast channel circuit connected between said power source terminal and said load for adjusting voltage values outputted by said outputting terminal and a slow channel circuit connected between said power source terminal and said load for stabilizing the voltage values outputted by said outputting terminal, wherein said fast channel circuit and said slow channel circuit are both connected to said outputting terminal; said slow channel circuit is connected to said reference voltage terminal; said fast channel circuit comprises a first FET and a controlling subcircuit connected to said first FET; said slow channel circuit comprises an operational amplifier connected to said reference voltage terminal, a first resistance connected to said operational amplifier, a second resistance connected to said first resistance and said first FET.

2. The low-dropout linear voltage stabilizing circuit, as recited in claim 1, wherein said slow channel circuit further comprises a second FET, a third FET, a fourth FET, a fifth FET, a sixth FET, a seventh FET, an eighth FET, a ninth FET and a tenth FET; said controlling subcircuit comprises a first capacitor, a second capacitor, said second FET, said third FET, said sixth FET and said seventh FET, wherein a first channel comprises said first capacitor, said first FET, said second FET, said sixth FET and said seventh FET; a second channel comprises said second capacitor, said third FET, said second FET and said first FET.

3. The low-dropout linear voltage stabilizing circuit, as recited in claim 2, wherein a gate electrode of said first FET is connected to a drain electrode of said second FET, a drain electrode of said sixth FET, a drain electrode of said fourth FET and a first terminal of said second capacitor; a drain electrode of said first FET is connected to a source electrode of said third FET, a first terminal of said first capacitor and a first terminal of said load.

4. The low-dropout linear voltage stabilizing circuit, as recited in claim 3, wherein a gate electrode of said second FET and a first voltage terminal are connected; a gate electrode of said third FET is connected to a gate electrode and a drain electrode of said ninth FET, a drain electrode of said tenth FET and a voltage controlling terminal; a gate electrode of said third FET is connected to a source electrode of said fourth FET, a second terminal of said second capacitor and a drain electrode of said fifth FET; a second voltage terminal is connected to a gate electrode of said fourth FET and a gate electrode of said sixth FET.

5. The low-dropout linear voltage stabilizing circuit, as recited in claim 4, wherein a third voltage terminal is connected to a gate electrode of said fifth FET, a gate electrode of said seventh FET and a gate electrode of said tenth FET; a source electrode of said sixth FET is connected to a drain electrode of said seventh FET and a second terminal of said first capacitor; a gate electrode of said eighth FET and an outputting terminal of said operational amplifier are connected with each other; a drain electrode of said eighth FET is connected to a first terminal of said first resistance, a source electrode of said ninth FET and an outputting controlling terminal.

6. The low-dropout linear voltage stabilizing circuit, as recited in claim 5, wherein a non-inverting inputting terminal of said operational amplifier is connected to a second terminal of said first resistance and a first terminal of said second resistance; an inverting inputting terminal of said operational amplifier is connected to said reference voltage terminal; a source electrode of said first FET, a source electrode of said second FET and a source electrode of said eighth FET are all connected to said power source terminal; a second terminal of said second resistance, a source terminal of said tenth FET, a source terminal of said seventh FET, a source electrode of said fifth FET and a second terminal of said load are all connected to the grounding terminal

7. A low-dropout linear voltage stabilizing system comprising a power source terminal, a reference voltage terminal, an outputting terminal, a load and a grounding terminal connected to said load, and further comprising a fast channel circuit connected between said power source terminal and said load for adjusting voltage values outputted by said outputting terminal and a slow channel circuit connected between said power source terminal and said load for stabilizing the voltage values outputted by said outputting terminal, wherein said fast channel circuit and said slow channel circuit are both connected to said outputting terminal; said slow channel circuit is connected to said reference voltage terminal.

8. The low-dropout linear voltage stabilizing system, as recited in claim 7, wherein said fast channel circuit comprises a first FET and a controlling subcircuit connected to said first FET; said slow channel circuit comprises an operational amplifier connected to said reference voltage terminal, a first resistance connected to said operational amplifier, a second resistance connected to said first resistance and said first FET.

9. The low-dropout linear voltage stabilizing system, as recited in claim 8, wherein said power source terminal and a source electrode of said first FET are connected with each other; a gate electrode of said first FET is connected to an outputting terminal of said operational amplifier and a first terminal of said controlling subcircuit; a drain electrode of said first FET is connected to a second terminal of said controlling subcircuit, a first terminal of said first resistance, a first terminal of said load and said outputting terminal

10. The low-dropout linear voltage stabilizing system, as recited in claim 9, wherein a non-inverting inputting terminal of said operational amplifier is connected to a second terminal of said first resistance and a first terminal of said second resistance; an inverting inputting terminal of said operational amplifier is connected to said reference voltage terminal; a second terminal of said second resistance and a second terminal of said load are both connected to said grounding terminal.
